(19) United States
(12) Patent Application Publication
(10) Pub. No.: US 2002/0016707 A1
(43) Pub. Date: Feb. 7, 2002

(54) Modeling of graphic images from text

(76) Inventors: Igor Devoino, Brighton, MA (US); Leonid Batchilo, Belmont, MA (US); Oleg Koshevoy, Malden, MA (US); Valery Tsourikov, Boston, MA (US)

Correspondence Address: STANGER & DREYFUS, 608 SHERWOOD PKWY, MOUNTAINSIDE, NJ, 07092, US

(21) Appl. No.: 09/833,021

(22) Filed: Apr. 11, 2001

Related U.S. Application Data
(63) Continuation-in-part of application No. 09/542,231, filed on Apr. 4, 2000.
(60) Provisional application No. 60/199,657, filed on Apr. 25, 2000.
(60) Provisional application No. 60/199,919, filed on Apr. 26, 2000.

(51) Int. Cl. G06F 9/45

(52) U.S. Cl. 703/22

(57) ABSTRACT

In a computer system, automatically displaying a graphic representation of natural language text.

A user enters or accesses text, the system semantically extracts text into subject-action-object structures (SAOs) SAO₁, SAO₂, SAO₃, . . . SAOₚ, composed of subjects S₁, S₂, S₃, . . . Sₚ, actions A₁, A₂, A₃, . . . Aₚ, and objects O₁, O₂, O₃, . . . Oₚ, and linking at least one SAO with another SAO when O₁=S₂ so that O₁ of SAO₁ becomes S₂ of SAO₂. The system and displays the linked SAOs on a screen or printout as a graphic representation of text.

### RELATED APPLICATIONS

This application is a continuation-in-part of U.S. Patent Applications No. 60/199,657 filed Apr. 25, 2000 (IMC-40P) and No. 60/199,919 filed Apr. 26, 2000 (IMC-40P1) both entitled Modeling of Graphic Images From Text, as well as Ser. No. 09/542,231 (IMC-26) filed Apr. 4, 2000 entitled Imaging And Analyzing Engineering Object Systems And Initializing Specific Design Changes, and copending U.S. patent application Ser. No. 09/541,192 filed Apr. 3, 2000. These applications are herewith incorporated herein by reference.

### FIELD OF THE INVENTION

This invention relates to engineering problem solving and design tools, and more particularly to computer based systems for aiding engineers, scientists, and the like to have a greater understanding of the products, processes, or machines they wish to improve and the related technical problems they wish to solve.

### BACKGROUND OF THE INVENTION

International application WO 98/24016 published Jun. 4, 1998 discloses a engineering analysis system for analyzing engineering object systems and for recommending elimination of object system components to produce desired system characteristics. A graphic model shows component boxes with interaction lines designated useful or harmful.

The aforementioned applications disclose a software system for manually creating graphic models of systems or objects and revising the models to conform them to desired characteristics. The user manually creates and revises the model graphically on the basis of concepts from various sources.

An object of the invention is to provide a computer system for automatically displaying a graphic representation of natural language text. A user enters or accesses text, the system semantically extracts text into subject-action-object structures (SAOs) SAO₁, SAO₂, SAO₃, . . . SAOₚ, composed of subjects S₁, S₂, S₃, . . . Sₚ, actions A₁, A₂, A₃, . . . Aₚ, and objects O₁, O₂, O₃, . . . Oₚ, and liking at least one SAO with another SAO when O₁=S₂ so that O₁ of SAO₁ becomes S₂ of SAO₂. The system and displays the linked SAOs on a screen or printout as a graphic representation of text.

### SUMMARY OF EMBODIMENTS OF THE INVENTION

An embodiment of the invention involves creating a graphic representation of an object system from a natural language textual description entered by the user as a document, and/or with a keyboard, and/or orally with a speech-to-text module, by semantically processing the text in subject-action-object (SAO) form and constructing a graphic image based on the processed SAOs.

These and other aspects, objects, and advantages of the invention will become evident from the following description of exemplary embodiments when read in light of the accompanying drawings.

### BRIEF DESCRIPTION OF THE DRAWINGS

FIG. 1 is a block diagram illustrating an embodiment of the invention.

FIG. 2 is a diagrammatic representation of a personal computer as part of a system that enables user interaction.

FIG. 3 illustrates an initial screen generated by the computer in FIG. 2 for performing operations by units in FIG. 1.

FIG. 4 illustrates a screen showing the results of a text generated graphic representation of a system.

FIG. 5 illustrates a screen showing the result of a user electing to edit the screen of FIG. 4.

FIG. 6 illustrates a screen showing the result of the user electing to edit a particular action in FIG. 4.

FIG. 7 illustrates a screen showing the result of the user electing in FIG. 6 to view trends on the subject elected in FIG. 6.

FIG. 8 illustrates a screen showing the result of the user electing another selection in FIG. 6.

FIG. 9 illustrates a screen showing the result of the user electing a solution from FIG. 8.

FIG. 10 illustrates a screen showing the result of the user selecting Concept list from FIG. 6.

FIG. 11 illustrates a screen showing the result of the user electing a concept from FIG. 10.

FIG. 12 illustrates generalized forms of subject—object relationships available according to embodiments of the invention.

### DETAILED DESCRIPTION OF PREFERRED EMBODIMENTS

The following disclosures are incorporated herein by reference:

I. System and on-line information service presently available at www.cobrain.com and the publicly available user manual therefor.

II. The software product presently marketed by Invention Machine Corporation of Boston, Mass., USA, under it's trademark “KNOWLEDGIST” and the publicly available user manual therefor.

III. WIPO Publication 00/14651, published Mar. 16, 2000.

IV. U.S. patent application Ser. No. 09/541,182 filed Apr. 3, 2000.

V. The software product presently marketed by Invention Machine Corporation of Boston, Mass., USA under its Trademark “TECHOPTIMIZER” and the publicly available user manual therefor.

VI. U.S. Pat. No. 5,901,068.

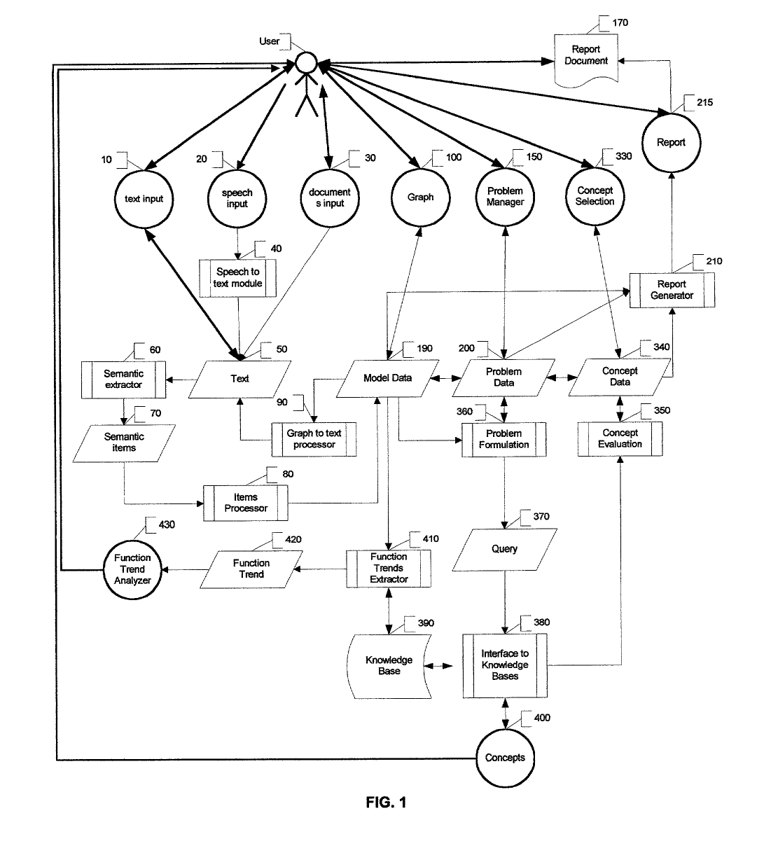

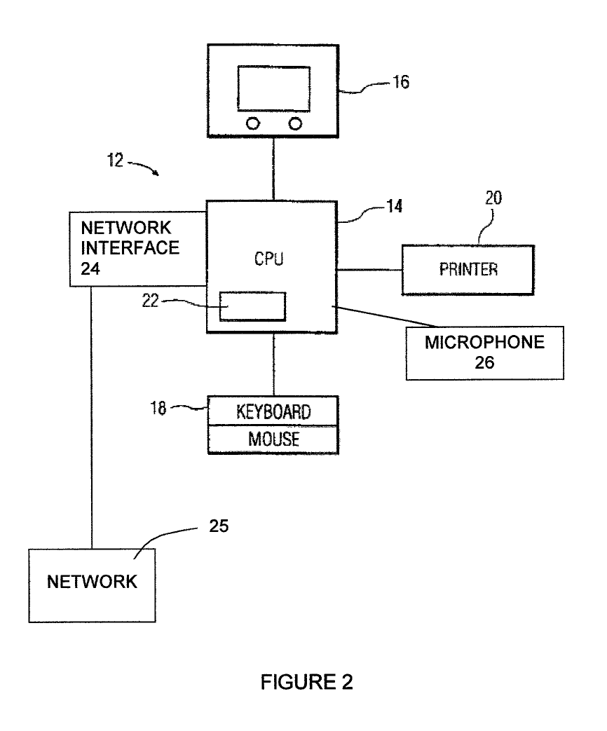

FIG. 1 is a flowchart of illustrating a software system embodying the invention. The software system and method embodying the invention is in the form of a program that resides in a personal computer 12 shown in FIG. 2. The computer 12 includes a CPU 14, a monitor 16, a keyboard/mouse 18, and a printer 20. The program may be stored on a portable disk and inserted in a disk reader slot 22 or on a fixed disc in the computer or on a ROM. According to another embodiment the program resides on a server and the user accesses the program via LAN (local area network), WAN (wide area network), or the Internet. Computer 12 can be conventional and be of any suitable make or brand. However, minimum performance specification for computer 12 should be Intel 486 with 20 Meg Hard Disk available, 4 Meg of RAM, and 75 MHz clock speed. The printer 20 provides a paper copy of details of a session when such is desired. A network interface 24, for example in the form of a modem, connects to information sources in external network 25 such as the Internet. A microphone 26 allows speech input to the computer 12. Other peripherals and modem/network interfaces can be provided as desired.

In FIG. 1, the units shown in circles serve to receive user-entered data and/or display data entered therein and data received by data processing; the parallelograms represent storage devices; and the rectangles with end boxes depict processing units.

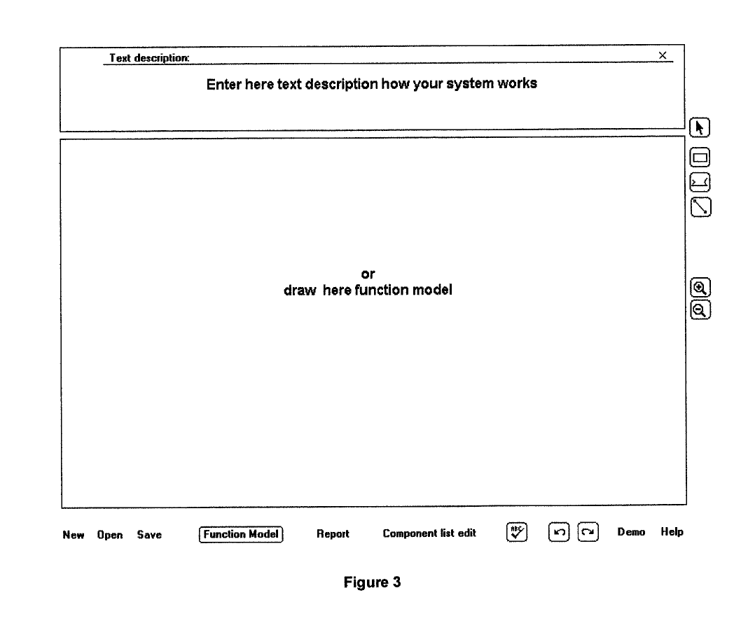

The system of FIGS. 1 and 2 starts by offering an initial screen as shown in FIG. 3. This invites the user to enter a text description or draw a function model. If the user chooses to enter a text description he/she has three choices, and the user may use any one of the choices or all of the choices.

In the first choice, the user uses the keyboard 16 to manually enter text, which describes an object system in the form of structure and operation or functionality of the device to be analyzed, into a text input unit 10 and then sends it to a text storage unit 50. The text input unit 10 also produces a display of the entered text in the monitor 16 at the top of the screen in FIG. 3. As the second choice, a speech input unit 20 allows a user to describe the structure, operation, and functionality by speech. As a third possible choice, the user enters text documents (from a scanner, computer, or Internet, etc.) into a document input unit 30 that also displays the data entered. The user may employ these choices in succession.

A speech-to-text unit recognizes speech from the speech input unit 20, transforms speech to text by means of speech to text unit 40, and sends it to a text storage unit 50. The latter stores entered text from the text input unit 10, speech-to-text unit 40, and document input unit 30. It also sends the text from the speech-to-text unit 40 to the text input 10 for display at the top of FIG. 3. The units 10, 20, 30, 40, and 50 may be considered part of an input section.

A semantic extractor unit 60 performs parsing of text stored in unit 50 and creates semantic structure of the text. The unit 60 extracts SAOs (Subject—Action—Object) and normalizes the text describing the structure. Extraction of SAOs and normalization are disclosed in the International Application WO 014651 published Mar. 16, 2000 as well as U.S. patent application Ser. No. 09/541,182 filed Apr. 3, 2000 and its aforementioned parent applications. Normalizing the text includes changing the text to active voice and to singular expressions. The unit 60 operates sentence by sentence. If the sentence contains an SAO it extracts the SAO. If the sentence contains an Object-Parameter link it extracts this relationship. It then defines the component's hierarchical relationships. That is, when one component contains another, the unit 60 defines the containing component as being hierarchically above or about the contained component.

A semantic items unit 70 stores all items, e.g. SAOs, Parameter-Object links, and hierarchy relationships, extracted from the analyzed text. An item processor unit 80 calculates possible relationships between SAOs, Parameter-Object links and hierarchy relationships extracted from text and builds a hierarchical function model. A Parameter-Object link is equivalent to a Subject-Action-Object link. The difference is that the Action is described as increase/decrease/stabilize/change/parameter. For example the sentence “Lever moves body” involves a Subject-Action-Object link. The sentence “Lever changes position of body” involves a parameter-object link. Sentences involving parameter object links are normalized to subject-action-parameter of-object format and hence included in SAOs.

To determine the relationships between SAOs the processor unit 80 compares SAOs and decides if any subjects or objects of SAOs are the same or synonymous. If an SAO₁ has a subject S₁, action A₁, and object O₁, and an SAO₂ has subject S₂, action A₂, and object O₂, and the object O₁ is the same as, or synonymous with, the subject S₂, the unit 80 joins SAO₁ with SAO₂ such that the sequence reads S₁-A₁-(O₁=S₂)-A₂-O₂. If an SAO₃ has a subject S₃, action A₃, and object O₃, and the Subject S₃ is the same or synonymous with object O₂, the unit 80 joins SAO₂ with SAO₃ such that the sequence expands to read S₁-A₁-(O₁=S₂)-A₂-(O₂=S₃)-A₃-O₃. The unit 80 may also branch the sequence. If the Subject S₃ is the same or synonymous with object O₁, the unit 80 joins SAO₂ with SAO₃ such that the sequence reads S₁-A₁-(O₁=S₂)-A₂-O₂ along one branch, and (O₁=S₃)-A₃-O₃ from a branch at (O₁=S₃). The SAOs may also branch at S₁ when S₁=S₃.

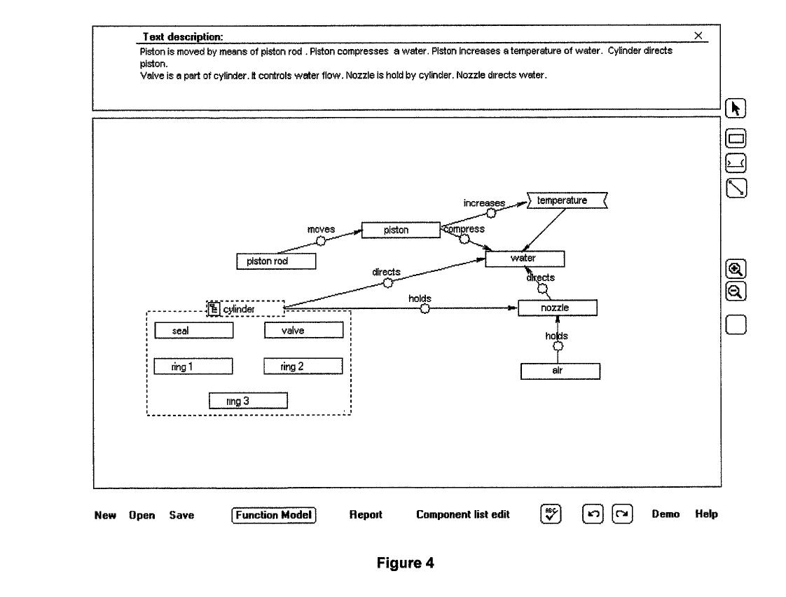

A model data 190 unit stores the data about the function model received from items processor unit 80 and applies it to a graph unit 100. The graph unit 100 displays data from model data unit 190 as a graphic representation of the function model of the object system under analysis. An example of text and graphic representation resulting therefrom appears in FIG. 4. The units 70, 80, 190, and 100 may be considered part of a graphic section that generates a graphic representation of the function model of the object system under analysis. The term generates includes revising the graphic representation.

In FIG. 4, the “piston rod” may be regarded as S₁, action “moves” as A₁, the “piston” as O₁=S₂=S₃, the action “compress” as A₂, the “water” as O₂, (“piston” again as O₁=S₂=S₃,) the action “increases” as A₃, and the “temperature” as O₃.

The user can also input data to graph unit 100 by drawing or selecting a symbol such as box at the right margin of FIG. 4 to represent a respective component, a concave ended box at the right margin of FIG. 4 to represent a parameter, and a line at the right margin of FIG. 4 to represent interaction between components. These inputs or changes to the function model are sent to model data unit 190. Specific components and parameters are drawn on screen. The user may input the graphic data either at the start or to alter the graphic result of the text input.

A graph to text processor unit 90 analyses all changes that are made in function model, generates texts that describes by function model in accordance with information that are stored in model data unit and sends this information to text unit 50. Also unit 90 changes (corrects or adds) text in accordance with data received from graph to text processor unit 90. This changes displays at unit 10. Unit 10 can display changes of the text made in unit 50.

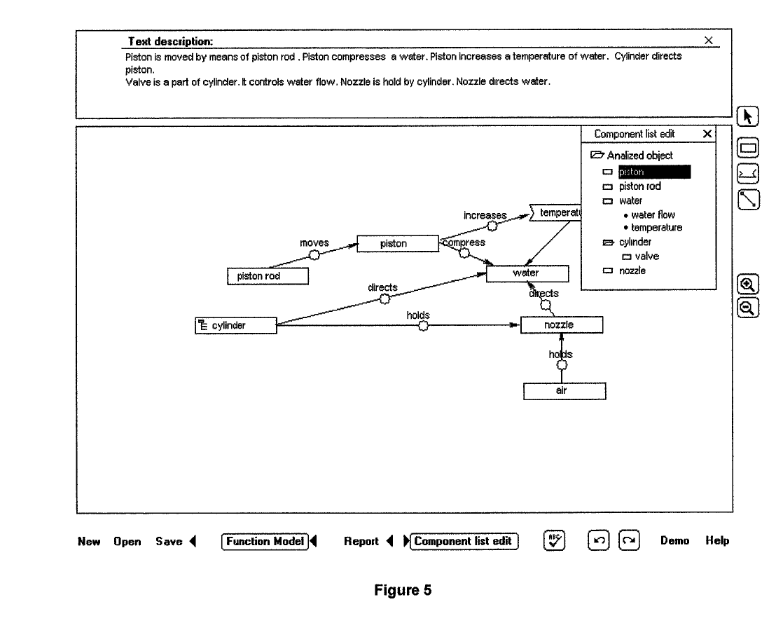

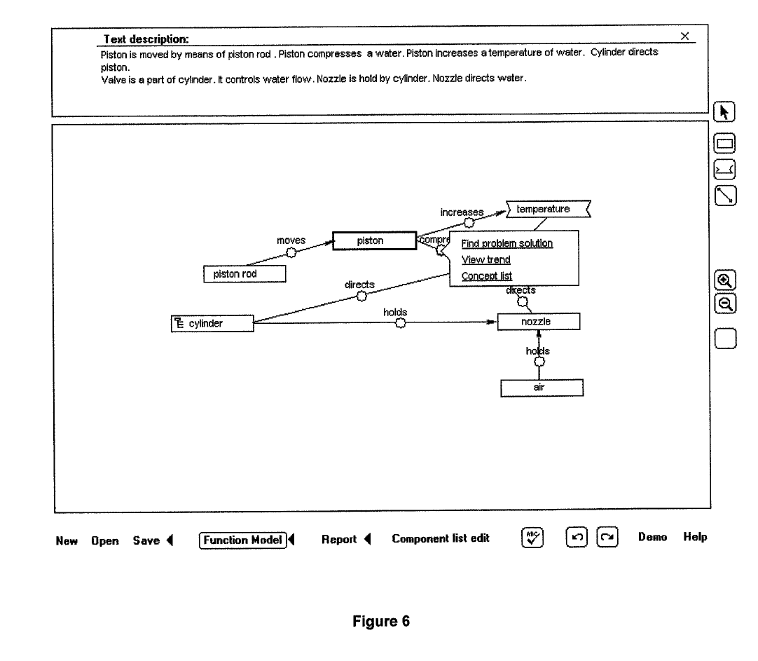

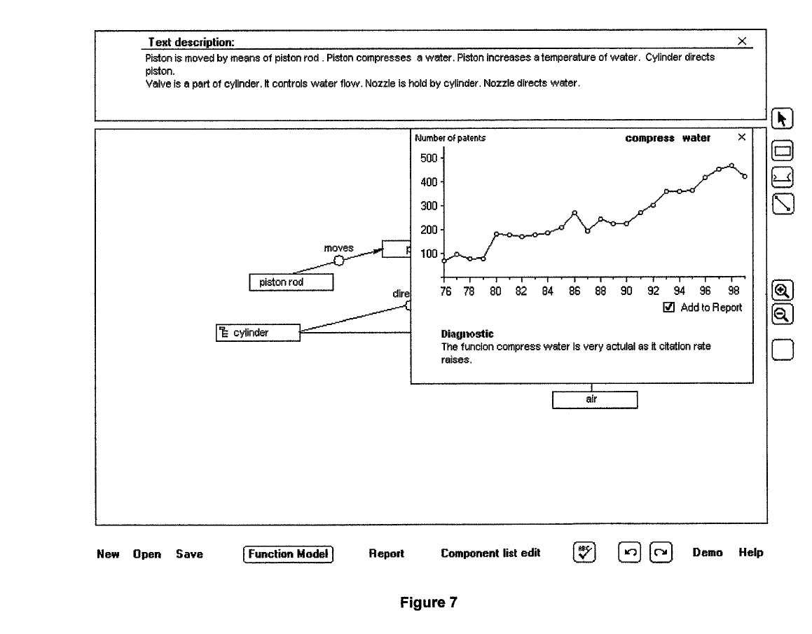

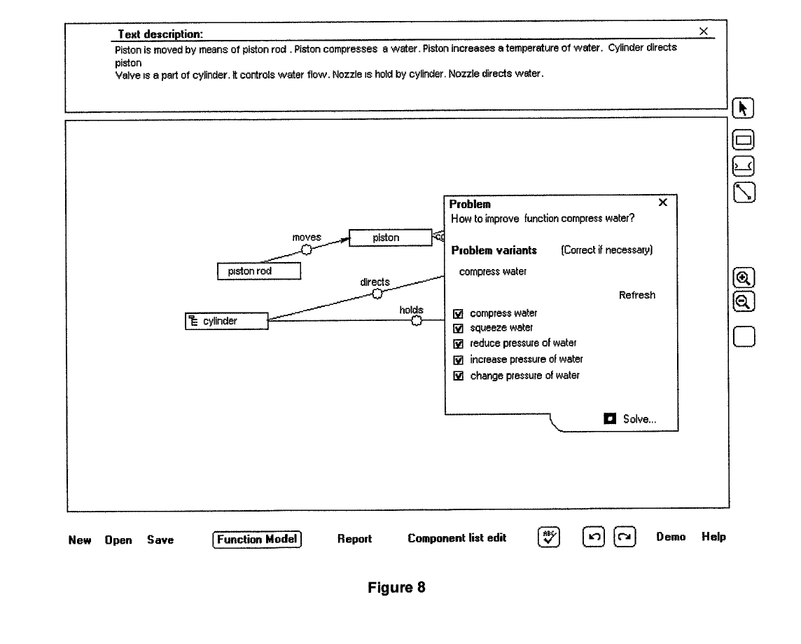

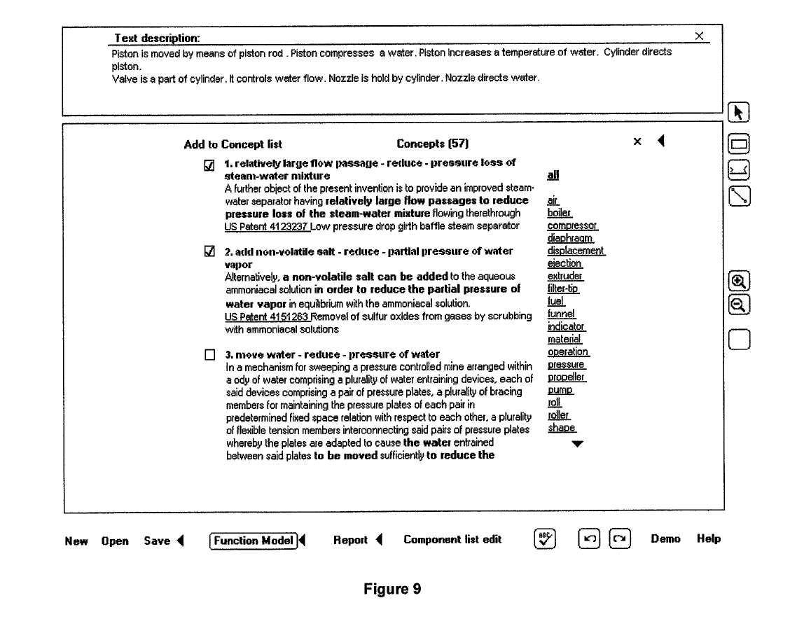

Clicking a component list edit button at the bottom of the screen in FIG. 4 creates a dialog box as shown in FIG. 5. This dialog box shows hierarchy of objects on screen like a hierarchy tree. User can change hierarchy of the objects in this tree. All changes are reflected in the graph. On the other hand clicking an open circle on a link between boxes produces a dialog as shown in FIG. 6. FIG. 7 shows the effects of clicking View Trend in FIG. 6 and FIG. 8 the effect of clicking Find Problem Solution in FIG. 6. FIG. 9 illustrates the effect of clicking Solve in a dialog box of FIG. 8.

In FIG. 1, a problem manager unit 150 receives data concerning a current problem from the user and displays the current problem and variants of problem reformulation. The user can select suitable variants or edit problem. A Report Document unit 170 issues reports that contain all data entered and generated during the session. A Problem Data unit 200 contains information about formulated problems and problem reformulations. A Report Generator unit 210 accumulates data from Model Data unit Problem Data and Concept Data and generates reports. A Report unit 215 displays the generated report. In a Concept Selection unit 330, a user enters a list of parameters that describe the concepts and defined strategies. These are used for calculation in unit 350. Unit 350 displays results of concepts evaluation calculated in Concept Evaluation unit 350. The user can use default strategies. All user entered data from Concept evaluation unit 350 are stored in a Concept Data unit 340. A Concept Evaluation unit 350 Calculates index for each concept in accordance data, entered by user.

A Problem formulation unit 360 analyzes the function model and generates formulation of problems, reformulations of problems. Unit 360 sends information about generated problems and their reformulations to the Problem data unit 200. Unit 360 generates and sends a query to Query unit 370. The Query unit 370 stores query for Knowledge databases. An Interface to Knowledge Base unit 380 sends the query to a Knowledge Base unit 390 and receives results relevant to query. Knowledge Base unit 390 contains indexed knowledge base of concepts in Subject-Action-Object format.

Concepts unit 400 displays possible concepts and the User can select suitable concepts as shown in FIG. 9. A Function trends extractor 410 selects data about functions from Model data unit 190, creates query to Knowledge Base unit 390, receives information about distribution in time of citation for selected function and generates diagnostic, and recommends if this function is perspective for usage or no. This unit analyses the trend in accordance with its behavior generates Diagnostics. A Function Trend unit 420 Stores Function Trend data. A Function Trend Analyzer 430 displays the function trend (distribution in time of citation for selected function) on screen.

As indicated, the system of FIGS. 1 and 2 achieves its ends by offering an initial screen as shown in FIG. 3. This invites the user to enter a text description or draw a function model. Here the User either enters text in text description window (thereby actuating unit 10) or draws a function model (thereby actuating Graph unit 100). In the first case the function model will automatically be generated in the function model window. In the second case text description of the model will be generated in text window. If user changes function model graphically, the text description is corrected automatically. If user changes the text description the changes are automatically reflected in function model. The Semantic extractor unit 60 performs parsing of text stored in unit 50 and creates the semantic structure of the text. SAOs (Subject—Action—Object) are extracted and normalized as, for example, in the aforementioned disclosure III namely publication WO 014651. Then Object-Parameter links are extracted and normalized. More specifically, the semantic extractor 60 normalizes text, for example text in passive voice, to produce an active voice wherein the actor is the subject. As a result, Subject—Action—Object structures and Subject—Action—Parameter—of the Object are displayed on the function model.

Component hierarchy relationships are then defined. Unit 60 analyzes hierarchy. It finds sentences that contains expression “part of”, “include”, “consist of” etc. and determines if one component is a part of another component. On the function model this is reflected as shown in FIG. 4. That is, FIG. 4 shows the cylinder to include a seal, a valve, a ring 1, a ring 2, and a ring 3; or stated otherwise that the seal, a valve, ring 1, ring 2, and ring 3 form part to the cylinder. The unit 60 sends the hierarchical relationships for storage to unit 70. Items Processor unit 80 calculates hierarchy relationships extracted from text and builds a hierarchical function model. The Model Data 190 unit stores the data about function model received from Item Processor Unit 80 and applies it to a Graph unit 100. The Graph unit 100 Displays data from Model Data unit 190 as a graphic representation of the function model of the object system under analysis as shown in FIG. 4.

Similarly, the function model reflects the SAOs as shown in FIG. 4. Here the text “Piston is moved by means of piston rod” appears as “piston rod” “moves” “piston”. Piston rod appears as the subject and piston the object. “Moves” comes out as the action. The unit 60 sends the SAOs for storage to unit 70. The items processor unit 80 builds the SAO model. The model data unit 190 stores the data from unit 80 and applies it to the graph unit 100.

If the user clicks on Component list edit button at the bottom of the screen, the screen of FIG. 5 appears with a Component list edit dialog box. The user can edit this tree, add or delete components, and change hierarchical relationships, define if the element of the tree is a component or parameter. All changes are reflected in the function model interactively. The changed data in the graph passes from unit 100, to unit 190, to unit 90, to unit 50, and to unit 10.

If the user puts the cursor on the circle representing an action as shown in FIG. 6, a small menu appears. In that menu, If user chooses the “View trend” Function in the small menu of FIG. 6, the trends extractor 410 selects data about selected functions from Model data unit 190 and then creates a query to Knowledge Base unit 420. The function trend extractor passes the received information to the Function Trend unit 420 that Stores Function Trend data. A Function Trend Analyzer 430 displays the function trend (distribution in time of citation for selected function) on screen as shown in FIG. 7. The unit 420 analyses the trend and in accordance with its behavior generates a diagnostic that gives user hints if this function has prospects or not.

If the user clicks on “Find problem solution” in FIG. 5, the user will see problem dialog box with Problem and problem reformulation in FIG. 8. User can check or uncheck suitable problem reformulation. If, in FIG. 8, the User clicks the “Solve” button Problem, formulation unit 360 sends information about generated problems and their reformulations to Problem data unit 200, and generates and sends a query to Query unit 370. Query unit 370 stores query for Knowledge databases 360. Interface to Knowledge Bases 380 send query to Knowledge Base unit 390 and receives results relevant to query. The knowledge base unit may connect to the Internet, may be stored locally, on a LAN, or WAN. Concepts unit 400 displays possible concepts as shown in the center in FIG. 9. The user can select suitable concepts. The user can limit the concepts by selecting from the list to the right of the concepts. The list may range from “all” to the limited areas listed. The user now returns to the screen in FIG. 6 where the user is invited to make further selections in the dialog box.

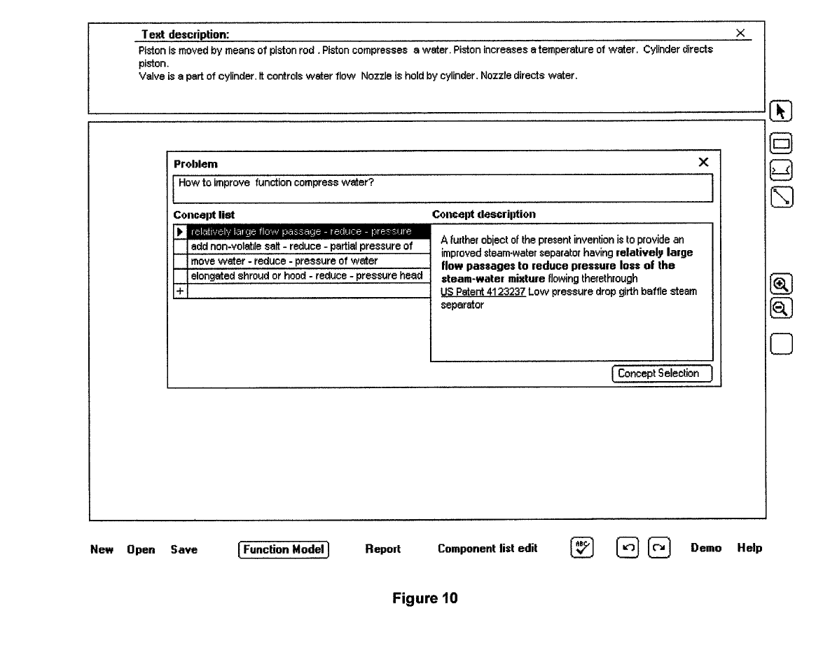

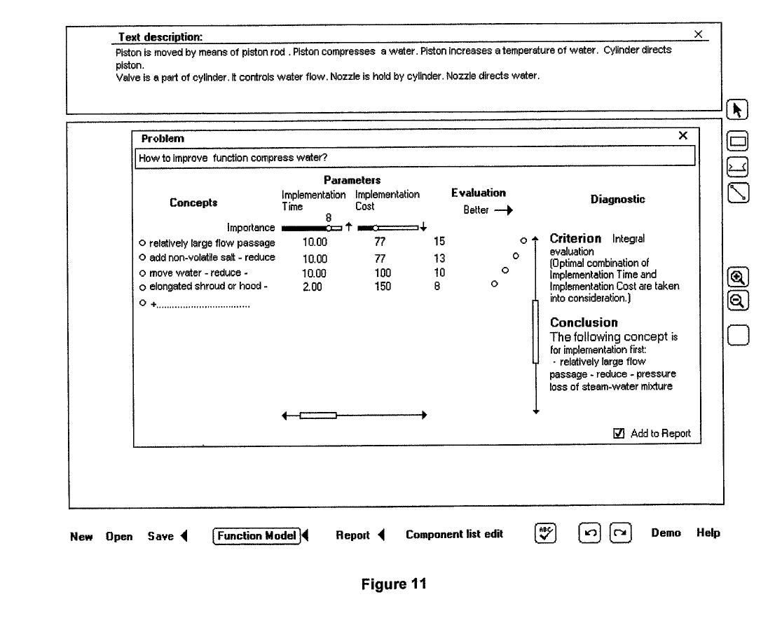

If the user selects “Concept list” in FIG. 6 the Problem Manager 150 displays a concepts list related to the problem as shown in FIG. 10. Only those concepts checked in FIG. 9 appear in FIG. 10. In FIG. 10, if the user clicks “Concept Selection” the concept selection dialog of FIG. 11 appears so as to compare concepts for the formulated problem and to select the best ones. In FIG. 11, a user enters a list of parameters, shown by a Concept Selection unit 330, which describe the concepts and defined strategies that are used, for calculation in Concept Evaluation unit 350. Concept Selection unit 330 generates display results of concept evaluation calculated in Concept Evaluation unit 350. All user-entered data are stored in the Concept Data unit 340. The user can use default strategies or create his/her own strategies.

Concept selection allows evaluating concepts in accordance with different strategies. There are several predefined strategies. Each strategy utilizes different formulas for calculation. The strategies appear in FIG. 11.

| Predefined | | |
|---|---|---|
| strategy | Formula | Comment |
| Implementation | K = −C − 10 × T | In accordance with this |
| time | | strategy the best concepts |
| | | have the lowest |
| | | implementation time. |
| Implementation | K = −10 × C − T | In accordance with this |
| cost | | strategy the best concepts |
| | | have the lowest |
| | | implementation cost. |

In these formulas:

K - evaluation index
C - standardized implementation cost,
T - standardized implementation time.

For the implementation time strategy, the time is multiplied, and for the implementation cost strategy the cost is multiplied.

When, in FIG. 10, the user clicks on the button “Concept selection”, the window of FIG. 11 appears. This shows the universal strategy. The calculations proceed in accordance with the following general formula.

K=Σ(Coefficient×Importance×Parameter)

Where

K—evaluation index;

Coefficient=+1 if parameter should be increased (condition Up),

Coefficient=−1 if parameter should be decreased (condition Down);

Importance=the value of importance;

Parameter=the standardized value of parameter that should be decreased.

The user can define his/her own strategy for concept selection. Details of such strategies appear in the copending application of Igor Devoino, Oleg Koshevoy, & Val Tsourikov, entitled Imaging And Analyzing Engineering Object Systems And Initiating Specific Design Changes filed Apr. 4, 2000.

The graph unit 100 invites the user to edit the graph as shown in FIG. 3. The user can then add components, links, etc. The model data storage unit then stores the new data and a graph to a text processor 90 converts the graphical data to text for storage in the text unit 50. The user accomplishes the editing by clicking on one of the icons at the right of the screen. The rectangular icon represents a component. The icon with concave ends represents a parameter and the diagonal line icon represents a link. By clicking on one of these icons such as the component icon, the graph unit produces a component list edit. This lists the components as well as parameters donated by small filled in circles. The user can then draw an additional component and link and graph unit 100. The latter feeds back through the model data storage unit 190, a graph detects processor 90 which converts the graphical information into text and stores it in the text storage unit 50 so that it can be displayed by the text input unit 10. As shown in FIG. 6, (the edited graph) placing the cursor on a component or link, produces a dialog box offering a find problem solution, view trend, and concepts list. Selecting view trend causes the functions trends extractor 410 to query a knowledge based 390 to obtain the graph of FIG. 7. The knowledge based 390 can be online, can include publications, patents, etc. The function trends extractor analyzes trend and trend lines. It shows whether interest in increasing or decreasing. Algorithms show increase, decrease, straight line, and ups and down trends. Other algorithms can also be used. This function trend is stored in function trend unit 420. A function trend analyzer displays this to the user after analyzer put 430.

In FIG. 6 if the user clicks find problem solution at unit 150, FIG. 8 displays a dialog box in unit 200. This provides a problem formulation in 360. It will reformulate expressions to different variant in two ways. Variant 1 is the direct format such as compress, squeeze. Variant 2 is the parameter object format such as increase pressure, and change pressure. The user checks or unchecks. When the user clicks Solve the user gets a query from unit 370 (interface 360 converts the query to complex form to access knowledge base 390) and receives result and sends the latter to 400. The result appears in FIG. 9 from unit 400. The user chooses by checking and click ‘x’ to close and goes back to FIG. 8 to click concept list and get FIG. 10. On right of FIG. 10 the user starts with quote “all” on the right. The list under “all” limits the list with the choices below.

If the user clicks on Concepts Lists in FIG. 6 we get the screen of FIG. 10. This figure displays the checked parts of FIG. 9. The user clicks concept selection dialog box in FIG. 10, (unit 350 and FIG. 1) to obtain implement time, cost evaluation as in the copending application of Igor Devoino, Oleg Koshevoy, & Val Tsourikov, entitled “Imaging And Analyzing Engineering Object Systems And Initiating Specific Design Change” filed Apr. 4, 2000.

As shown in FIG. 4, the unit 60 makes SAO become the subject of the next SAO. For example, the object “piston” of piston rod-moves-piston, becomes the subject of piston-compresses-water. “Piston” also becomes the subject of piston-increases-temperature. Moreover, in unit 60, the subject “cylinder” of SAO cylinder-directs-water is also the subject of cylinder-holds-nozzle. The unit 60 makes the object “nozzle” of cylinder-holds-nozzle become the subject of nozzle-directs-water.

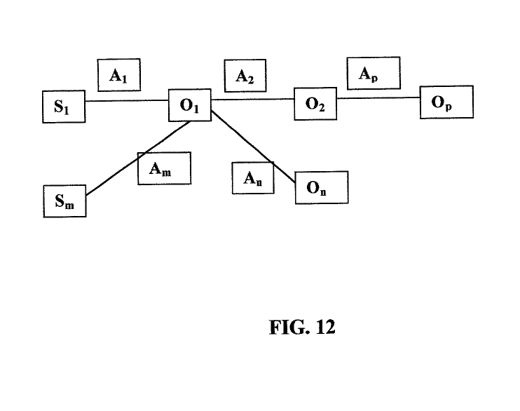

A generalized form of the object subject relationships appears in the diagram of FIG. 12. Here, subjects S₁ . . . Sₚ, actions A₁ . . . Aₚ, and objects O₁ . . . Oₚ form SAOs.

In:

S₁ A₁ O₁

S₂ A₂ O₂

:

Sₘ Aₘ Oₘ

Sₙ Aₙ Oₙ

Sₚ Aₚ Oₚ

Where

O₁=S₂

O₁=Sₙ

O₂=Sₚ

Oₘ=O₁

this constitutes extending and branching of the SAOs into the forms shown in FIGS. 4 and 12.

According to an embodiment of the invention an analytic system for analyzing an object system involves an input section responsive to user entry of text from a text document and/or text entered with a keyboard and/or orally with a speech-to-text module, a processing section responsive to the input section for semantically processing the text in subject-action-object form; and a graphic section responsive to the semantically processed text in subject-action-object form of said processing section for generating a first graphic segment or representation based on the subject-action-object processed, and linking successive graphic segments or representation of actions and objects in text semantically processed in subject-action-object form onto a previous graphic segment or representation with the object of the previous segment serving as the subject of the subsequent segment.

It will be understood that various other display symbols, emblems, colors, and configurations can be used instead of those disclosed for the exemplary embodiments herein. Also, various improvements and modifications can be made to the herein disclosed exemplary embodiments without departing from the spirit and scope of the present invention. The system and method according to the inventive principles herein are necessarily not dependent upon the precise exemplary hardware or software architecture disclosed herein.

What is claimed is:

1. A computer arrangement for automatically displaying a graphic representation of natural language text, comprising:
an analytic system for analyzing natural language text, said analytic system including:
an input section responsive to user entry of text from a text document, or text entered with a keyboard, or text entered orally with a speech-to-text module;
a processing section responsive to the input section for semantically extracting entered text into subject-action-object structures (SAOs) SAO₁, SAO₂, SAO₃, . . . SAOₚ, composed of subjects S₁, S₂, S₃, . . . Sₚ, actions A₁, A₂, A₃, . . . Aₚ, and objects O₁, O₂, O₃, . . . Oₚ, said processing section linking at least one SAO with another SAO so that when O₁=S₂, O₁ of SAO₁ becomes S₂ of SAO₂.
a graphic section responsive to the processing section for displaying the linked SAOs on a screen as a graphic representation of text.

2. A computer arrangement as in claim 1, wherein, when S₁=S₃, said processing section further responds to said entry section for linking SAO₁ with SAO₃ such that S₁ of SAO₁ serves as S₃ of SAO₃.

3. A computer arrangement as in claim 1, wherein subjects S₁, S₂, S₃, . . . Sₚ, actions A₁, A₂, A₃, . . . Aₚ, and objects O₁, O₂, O₃, . . . Oₚ refer to components and said actions A₁, A₂, A₃, . . . Aₚ refer to actions between said subjects and objects, and wherein said graphic section is further responsive to the processing section for generating on the screen representations of components on the basis of their subject and object status, and representations of the interrelationships between the components on the basis of the action between subject and object.

4. A computer arrangement as in claim 1, wherein said graphic section is further responsive to the processing section for generating on the computer screen block representations of components and lines interconnecting said block representations to symbolize interrelationships between the generated block representations on the basis of the subject and object and actions.

5. A computer arrangement as in claim 3, wherein said processing section further defines the hierarchical relationships of said components when one component contains another component as having a higher hierarchy than a contained component, and graphic section displays on the screen a higher component about or above a lower component.

6. A computer arrangement as in claim 1, wherein said processing section semantically processes the text by extracting subject-action-object forms and normalizes the text by changing the text to active voice and to singular expressions.

7. A computer arrangement as in claim 6, wherein said processing section includes a storage segment for storing the SAOs.

8. A computer arrangement as in claim 1, wherein said processing section includes an items processor for deciding if any subjects or objects of SAOs are the same or synonymous, and if object O₁ is the same as, or synonymous with, the subject S₂, the items processor joins SAO₁ with SAO₂ such that the sequence reads S₁-A₁-(O₁=S₂)-A₂-O₂.

9. A computer arrangement as in claim 8, wherein said items processor decides if an SAO₃ has a subject S₃, action A₃, and object O₃, and the subject S₃ is the same or synonymous with object O₂, the items processor joins SAO₂ with SAO₃ such that the sequence expands to read S₁-A₁-(O₁=S₂)-A₂-(O₂=S₃)-A₃-O₃.

10. A computer arrangement as in claim 8, wherein said items processor decides if the subject S₃ is the same or synonymous with object O₁, the items processor joins SAO₂ with SAO₃ such that the sequence reads S₁-A₁-(O₁=S₂=S₃)-A₂-O₂ along one branch, and (O₁=S₃)-A₃-O₃ from a branch at (O₁=S₂=S₃).

11. A computer arrangement as in claim 8, wherein said items processor decides if the subject S₃ is the same or synonymous with subject S₁, the items processor joins SAO₁ with SAO₃ such that the sequence reads (S₁=S₃)-A₁-(O₁=S₂)-A₂-O₂ along one branch, and (S₁=S₃)-A₃-O₃ from a branch at (S₁=S₃).

12. A computer arrangement as in claim 1, wherein said analytic system includes access to a knowledge base, and allows a user to click on one of a component and action to obtain a dialogue box which offers a user to view a trend from the knowledge base of publications available over a time period.

13. A computer arrangement as in claim 12, wherein said analytic system includes access to a knowledge base, and allows a user to click on one of a component and action to obtain a dialogue box which offers a user to find a problem solution from the knowledge base of publications available over a time period.

14. A computer arrangement as in claim 12, wherein said analytic system includes statements of a problem and variations, said analytic system including a unit for storing problems and variations and actuating said dialogue box to invite the user to request possible solutions.

15. A computer arrangement as in claim 14, wherein said analytic system includes access to a knowledge base of solutions and environments for such solutions as well as references to publications showing such solutions.

16. A computer arrangement as in claim 15, wherein said analytic system actuates the display to invite the user to request solutions for each of a plurality of components.

17. A computer arrangement as in claim 15, wherein said analytic system actuates the display to invite the user to request different concepts for each of a plurality of components.

18. A computer arrangement as in claim 15, wherein said analytic system actuates the display to invite the user to request different concepts for each of a plurality of components and to evaluate the concepts and defined strategies for a problem.

19. A computer arrangement as in claim 15, wherein said analytic system actuates the display to create a dialog box to invite the user to request different concepts for each of a plurality of components and to use a default strategy or define a strategy.

20. A computer program as in claim 15, wherein said analytic system actuates the display to create a dialog box to invite the user to request different concepts for each of a plurality of components and to use a default strategy or define a strategy on the basis of implementation time or cost.

21. A computer method for automatically displaying a graphic representation of natural language text, comprising:
entering text from a text document, or text entered with a keyboard, or text entered orally with a speech-to-text module;
processing extracting from the entered text subject-action-object structures (SAOs) SAO₁, SAO₂, SAO₃, . . . SAOₚ, composed of subjects S₁, S₂, S₃, . . . Sₚ, actions A₁, A₂, A₃, . . . Aₚ, and objects O₁, O₂, O₃, . . . Oₚ, and linking at least one SAO with another SAO so that when O₁=S₂, O₁ of SAO₁ becomes S₂ of SAO₂.
displaying the linked SAOs on a screen as a graphic representation of the text.

22. A computer method as in claim 21, wherein, when S₁=S₃, further responds to said entering step and links SAO₁ with SAO₃ such that S₁ of SAO₁ serves as S₃ of SAO₃.

23. A computer method as in claim 21, wherein subjects S₁, S₂, S₃, . . . Sₚ, actions A₁, A₂, A₃, . . . Aₚ, and objects O₁, O₂, O₃, . . . Oₚ refer to components and said actions A₁, A₂, A₃, . . . Aₚ refer to actions between said subjects and objects, and wherein said displaying step further generates on the screen representations of components on the basis of their subject and object status, and representations of the interrelationships between the components, and products on the basis of the action between subject and object.

24. A computer method as in claim 21, wherein said displaying step further generates on the computer screen block representations of components and lines interconnecting said block representations to symbolize interrelationships between the generated block representations on the basis of the subject and object and actions.

25. A computer method as in claim 23, wherein said processing step further defines hierarchical relationships of said components when one component contains another component as having a higher hierarchy than a contained component, and displaying step displays on the screen a higher component about or above a lower component.

26. A computer method as in claim 1, wherein said processing step semantically processes the text by extracting subject-action-object forms and normalizes the text by changing the text to active voice and to singular expressions.

27. A computer method as in claim 6, wherein said processing step includes a step of storing the SAOs.

28. A computer method as in claim 1, wherein said processing step includes an itemizing step for deciding if any subjects or objects of SAOs are the same or synonymous, and if object O₁ is the same as, or synonymous with, the subject S₂, joining SAO₁ with SAO₂ such that the sequence reads S₁-A₁-(O₁=S₂)-A₂-O₂.

29. A computer method as in claim 8, wherein said itemizing step decides if an SAO₃ has a subject S₃, action A₃, and object O₃, and the subject S₃ is the same or synonymous with object O₂, the items processor joins SAO₂ with SAO₃ such that the sequence expands to read S₁-A₁-(O₁=S₂)-A₂-(O₂=S₃)-A₃-O₃.

30. A computer method as in claim 8, wherein said itemizing step decides if the subject S₃ is the same or synonymous with object O₁, the items processor joins SAO₂ with SAO₃ such that the sequence reads S₁-A₁-(O₁=S₂=S₃)-A₂-O₂ along one branch, and (O₁=S₃)-A₃-O₃ from a branch at (O₁=S₂=S₃).

31. A computer method as in claim 8, wherein said itemizing step decides if the subject S₃ is the same or synonymous with subject S₁, the items processor joins SAO₁ with SAO₃ such that the sequence reads (S₁=S₃)-A₁-(O₁=S₂)-A₂-O₂ along one branch, and (S₁=S₃)-A₃-O₃ from a branch at (S₁=S₃).

32. A method as in claim 30, further comprising accessing a knowledge base, and allowing a user to click on one of a component and action to obtain a dialogue box which offers a user the opportunity to find a problem solution from the knowledge base of publications available over a period dates.

33. A method as in claim 30, further comprising accessing a knowledge base, and allowing a user to click on one of a component and action to obtain a dialogue box which offers a user a concept list from the knowledge base of publications available over a time period.

34. A method as in claim 32, further comprising generating statements of a problem and variations, and actuating said dialogue box to invite the user to request possible solutions.

35. A method as in claim 34, further comprising accessing a knowledge base of solutions and environments for such solutions as well as references to publications showing such solutions.

36. A method as in claim 35, further comprising actuating the display to invite the user to request solutions for each of a plurality of environments.

37. A method as in claim 35, further comprising actuating the display to invite the user to request different concepts for each of a plurality of components.

38. A method as in claim 35, further comprising actuating the display to invite the user to request different concepts for each of a plurality of components and to evaluate the concepts and defined strategies for a problem.

39. A method as in claim 35, further comprising actuating the display to create a dialog box to invite the user to request different concepts for each of a plurality of components and to use a default strategy or define a strategy.

40. A method as in claim 35, further comprising actuating the display to create a dialog box to invite the user to request different concepts for each of a plurality of components and to use a default strategy or define a strategy on the basis of implementation time or cost.
